(19) United States
(12) Patent Application Publication
(10) Pub. No.: US 2009/0079920 A1
(43) Pub. Date: Mar. 26, 2009

(54) DISPLAY DEVICE AND METHOD OF MANUFACTURING THE SAME

(75) Inventor: Masaru AOKI, Kumamoto (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 12/212,847

(22) Filed: Sep. 18, 2008

(30) Foreign Application Priority Data
Sep. 20, 2007 (JP) 2007-243821
Jun. 3, 2008 (JP) 2008-145751

(51) Int. Cl. G02F 1/1335

(52) U.S. Cl. 349/114; 349/187

(57) ABSTRACT

Provided is a method of manufacturing a display device, the display device including: a TFT array substrate; an opposing substrate opposed to the TFT array substrate; and a liquid crystal layer sandwiched between the TFT array substrate and the opposing substrate, the method including the steps of: forming an organic planarization film on the TFT array substrate; forming a reflective pixel electrode on the organic planarization film; forming a step at the organic planarization film; and depositing an upper transparent conductive film so as to be divided at the step of the organic planarization film.

### BACKGROUND OF THE INVENTION

1. Field of the Invention

The present invention relates to a display device and a method of manufacturing the same.

2. Description of Related Art

In recent years, liquid crystal display devices using a liquid crystal as an electro-optic element for display, which have advantageous features such as low power consumption and a thin body, have been mass-produced as one of flat panel displays in substitution for a CRT.

Examples of the liquid crystal display devices include a passive (simple) matrix liquid crystal display device and an active matrix liquid crystal display device. Examples of the active matrix liquid crystal display device include a TFT-LCD using a thin film transistor (hereinafter, abbreviated as “TFT”) as a switching element. The TFT-LCD has advantageous features in terms of portability and display quality as compared with the CRT and the simple matrix liquid crystal display device. For this reason, the TFT-LCD is widely put into practical use for laptop personal computers and the like.

In the TFT-LCD, a liquid crystal layer is sandwiched between a TFT array substrate on which TFTs are formed in an array, and an opposing substrate.

Examples of the TFT-LCD include a reflective TFT-LCD, a transmissive TFT-LCD, and a transflective TFT-LCD. The transflective TFT-LCD has both reflective and transmissive characteristics. The reflective TFT-LCD includes a reflecting layer formed on the TFT array substrate to reflect surrounding light, thereby performing display. The transmissive TFT-LCD includes light transmitting layers formed on both the TFT array substrate and the opposing substrate. Further, the transmissive TFT-LCD allows light from a light source, which is provided on a rear surface or a side surface thereof, to transmit through the light transmitting layers, thereby performing display.

The reflective TFT-LCD has excellent display characteristics for outdoor use. The reflective TFT-LCD, however, has a low level of visibility indoors where the surrounding light is low. Meanwhile, the transmissive TFT-LCD has excellent display characteristics indoors. The transmissive TFT-LCD, however, has a low level of visibility outdoors because the light from the light source is more intense than the surrounding light.

In recent years, there is an increasing demand for mobile display devices such as a small display for a cellular phone and a portable music player, and a medium-size display for a potable media player, a PDA, and an onboard navigation system. The transflective TFT-LCD has excellent display characteristics both outdoors and indoors. For this reason, with the increasing demand for those mobile display devices, a demand for the transflective TFT-LCD is increasing.

In the TFT-LCD, a signal line and a gate line are provided for each pixel so as to intersect with each other on a glass substrate by using semiconductor technology. Further, in the TFT-LCD, a TFT is formed at an intersection between the signal line and the gate line. Furthermore, in the TFT-LCD, a reflective pixel electrode (reflecting layer) or a transmissive pixel electrode (light transmitting layer) is formed for each pixel. Thus, the TFT array substrate is formed. Accordingly, a large number of steps are required to manufacture the TFT array substrate. As a result, there arises a problem in that the number of devices necessary for manufacturing the TFT array substrate increases, which leads to an increase in manufacturing costs. In particular, in the transflective TFT-LCD, it is necessary to form both the reflective pixel electrode and the transmissive pixel electrode for each pixel on the TFT array substrate. Accordingly, the number of manufacturing steps of the transflective TFT-LCD is much larger than that of the reflective TFT-LCD and the transmissive TFT-LCD. As a result, in the transflective TFT-LCD, manufacturing costs increase. For this reason, a reduction in the number of manufacturing steps is required.

In the transmissive TFT-LCD, a transmissive pixel electrode is formed on the TFT array substrate, and an opposing electrode is formed on the opposing substrate. The transmissive pixel electrode and the opposing electrode are each formed of a transparent conductive film such as ITO (Indium Tin Oxide). Thus, a work function of the transmissive pixel electrode can be set to be substantially equal to a work function of the opposing electrode. As a result, in the case of performing alternate current drive of a liquid crystal, the transmissive pixel electrode and the opposing electrode enable application of positive and negative voltages to the liquid crystal under substantially the same conditions. On the other hand, in the transflective TFT-LCD, the transmissive pixel electrode and the reflective pixel electrode are formed on the TFT array substrate. Further, in the transflective TFT-LCD, the opposing electrode is formed on the opposing substrate. The transmissive pixel electrode and the opposing electrode are each formed of a transparent conductive film such as ITO. Meanwhile, the reflective pixel electrode is formed of a metal film such as Al. Accordingly, the work function of the reflective pixel electrode is different from that of the opposing electrode. As a result, depending on drive conditions for the liquid crystal, flicker of a display occurs. Further, depending on the drive conditions for the liquid crystal, a phenomenon called image sticking is caused due to a difference in work function between the reflective pixel electrode and the opposing electrode. In this case, the image sticking refers to a phenomenon in which a residual image is formed from previous data, which deteriorates the display quality.

In this case, to avoid the flicker or image sticking, Japanese Unexamined Patent Application Publication No. 2005-275323 discloses a technology in which a transparent conductive film made of the same material as that of an opposing electrode is formed on a reflective pixel electrode. In the technology disclosed in Japanese Unexamined Patent Application Publication No. 2005-275323, a metal film forming the reflective pixel electrode is first deposited. Next, a transparent conductive film is deposited on the metal film. Then, the films are collectively etched using the same mask and the same etching solution. Thus, the transparent conductive film having the same pattern as that of the reflective pixel electrode is formed on the reflective pixel electrode.

When the metal film and the transparent conductive film are subjected to collective wet etching by the method disclosed in Japanese Unexamined Patent Application Publication No. 2005-275323, however, an edge portion of the transparent conductive film may extend off an edge portion of the metal film and remain in an eaves-like shape. FIG. 9A to 9D are cross-sectional views each schematically showing a part of a process for manufacturing a TFT array substrate of a transflective liquid crystal display device as disclosed in Japanese Unexamined Patent Application Publication No. 2005-275323.

In the method disclosed in Japanese Unexamined Patent Application Publication No. 2005-275323, an interlayer insulating film 21 is formed above a TFT (not shown), a scanning signal line (not shown), and a display signal line (not shown). Next, a lower transparent conductive film 22 serving as a transmissive pixel electrode is deposited on the interlayer insulating film 21. Then, patterning is performed to form a transmissive pixel electrode (see FIG. 9A). Further, a metal film 23 serving as a reflective pixel electrode is deposited so as to cover the lower transparent conductive film 22. Then, on the metal film 23, an upper transparent conductive film 24 is formed so as to prevent flicker and image sticking from occurring. Further, on the upper transparent conductive film 24, a resist 25 is formed into a desired shape (see FIG. 9B). Then, the metal film 23 and the upper transparent conductive film 24 are collectively subjected to wet etching (see FIG. 9C). After that, the resist 25 is removed (see FIG. 9D).

Referring to FIG. 9D, when a multiplayer thin film pattern is formed by employment of the method disclosed in Japanese Unexamined Patent Application Publication No. 2005-275323, an edge portion of the upper transparent conductive film 24 formed in the upper layer laterally extends off an edge portion of the metal film 23 formed below the upper transparent conductive film 24 and remains in an eaves-like shape. In particular, when the collective etching is performed using isotropic etching such as wet etching, the edge portion of the upper transparent conductive film 24 is more likely to remain in an eaves-like shape.

Then, as described above, when the edge portion of the upper transparent conductive film 24 is formed into an eaves-like shape, the eaves-like portion is removed during a post-process. Particularly in a process for rubbing a substrate, for example, the eaves-like portion is more likely to be removed. Further, the eaves-like portion thus removed causes a foreign substance, which may lead to a short-circuit between adjacent pixels or a short-circuit between pixel electrodes (transmissive pixel electrode and reflective pixel electrode). Thus, the removed eaves-like portion causes a display failure. If the eaves-like portion is formed in a multilayer thin film pattern, in a process of coating the multilayer thin film pattern with a coating film, the coating film has a stepped cut portion at the eaves-like portion. Further, when the coating film is a protection insulating film, an insulating failure occurs at the stepped cut portion. Furthermore, when the coating film is a conductive film, a connection failure occurs at the stepped cut portion. As a distance between adjacent pixels is to be reduced in the future, it is necessary to more effectively prevent the eaves-like portion from being formed.

Further, the method disclosed in Japanese Unexamined Patent Application Publication No. 2005-275323 includes a process in which a lower transparent conductive film is deposited and patterned. After the process, a process in which a metal film and an upper transparent conductive film are deposited and then subjected to collective wet etching is carried out. Thus, the number of manufacturing processes increases, which results in an increase in manufacturing costs. Furthermore, as the number of manufacturing processes increases, defects due to a foreign substance or the like are more liable to occur, which leads to a deterioration in yield.

Japanese Unexamined Patent Application Publication No. 2005-215277 discloses a technology of manufacturing a transflective TFT-LCD while achieving a reduction in the number of manufacturing processes. Conventionally, the TFT array substrate is formed by repeatedly performing a photolithography process six times. Japanese Unexamined Patent Application Publication No. 2005-215277 discloses a method of forming the TFT array substrate by repeatedly performing a photolithography process five times. Specifically, in the technology disclosed in Japanese Unexamined Patent Application Publication No. 2005-215277, a photomask (photosensitive resin pattern) is formed using half-tone exposure technology. Further, the reflective pixel electrode and the transmissive pixel electrode are formed by using a single photomask. Thus, the number of manufacturing processes is reduced.

Specifically, in the technology disclosed in Japanese Unexamined Patent Application Publication No. 2005-215277, a gate electrode and line, an insulating film, a semiconductor layer, a source/drain electrode and line, an organic planarization layer, a contact hole formed between those layers, and the like are first formed on a substrate. Then, a transparent conductive film serving as a transmissive pixel electrode is deposited. After that, a metal film is deposited on a transparent conductive film. Then, a photomask is formed using half-tone exposure technology. In this case, the film thickness of the photomask formed in a reflective portion in which the reflective pixel electrode is formed is greater than that of the photomask formed in a transmissive portion. Herein, the transmissive portion refers to a portion of a pixel area excluding the reflective portion. Then, the metal film is etched, thereby exposing a portion of the transparent conductive film which is formed in an area other than the area covered with the photomask. Then, an ashing process is carried out to reduce the film thickness of the photomask. As a result, the metal film formed in the transmissive portion is exposed. Herein, the ashing process refers to a process for performing ashing elimination for oxidative decomposition on the resist by a dry etcher or the like, that is, oxygen plasma treatment. In this case, in the reflective portion, the photomask reduced in film thickness is left. Then, the transparent conductive film formed in the area other than the area protected by the photomask and the metal film of the transmissive portion is etched. Then, the metal film formed in the transmissive portion is etched, thereby forming the transmissive pixel electrode. Further, the photomask remaining in the reflective portion is removed using a resist removing solution, to thereby form the reflective pixel electrode.

In the method of manufacturing the TFT array substrate as disclosed in Japanese Unexamined Patent Application Publication No. 2005-215277, however, the transparent conductive film is exposed in the case of performing the ashing process. When the ashing process is carried out in the state where the surface of the transparent conductive film is exposed, abnormal electrical discharge occurs. As a result, not only the transparent conductive film but also an uneven layer and an insulating layer, which are formed below the transparent conductive film, and a wiring layer formed below the uneven layer and the insulating layer are damaged. This causes a display failure due to dielectric breakdown or pattern disconnection.

In this case, as the method for preventing a failure caused by the ashing process, a method in which wet etching is performed after formation of a photomask and the ashing process is performed thereafter is described with reference to the process cross-sectional views shown in FIGS. 10A and 10B.

First, a Mo film having a thickness of 250 nm is deposited on a glass substrate 31 by using a sputtering apparatus. Next, a resist is patterned using a photolithography apparatus. Then, a wet etching process is carried out to remove portions of the Mo film which are not protected by the resist. Then, a resist removing process is carried out to remove the resist. Thus, gate lines 32 are formed (see FIG. 10A column (a); gate forming step).

Next, an insulating film (Sin: 400 nm in film thickness) 33 and semiconductor films (a-Si (i): 130 in film thickness, a-Si (n): 50 nm in film thickness) are formed using a CVD apparatus. Then, a resist is patterned using a photolithography apparatus. Then, a dry etching process is carried out to remove the portions of the semiconductor films which are not protected by the resist. After that, a resist removing process is carried out to remove the resist. Thus, semiconductor layers 34 are formed (see FIG. 10A column (b) semiconductor layer forming step).

Next, a Mo film having a thickness of 300 nm is deposited using a sputtering apparatus. Then, a resist is patterned using a photolithography apparatus. Further, a wet etching process is carried out to remove the portions of the Mo film which are not protected by the resist. Then, a dry etching process is carried out to remove the portions of the semiconductor film (a-Si (n)) which are not protected by the resist. Further, a resist removing process is carried out to remove the resist. Thus, a source/drain line 35 is formed (see FIG. 10A column (c); source/drain and channel forming step).

Next, an insulating film (SiN: 100 nm in film thickness) 36 is deposited using a CVD apparatus (see FIG. 10A column (c)). Then, a photosensitive organic resin film is applied and formed. Further, an organic planarization film 37 having an uneven shape is formed with a photomask for forming an uneven pattern by a photolithography apparatus. In this case, the uneven shape is formed on the reflective portion. After that, a dry etching process is carried out to remove the insulating film formed in openings of contact holes (see FIG. 10A column (d); organic planarization film forming step).

Next, a lower transparent conductive film (ITO (Indium Tin Oxide) film: 80 nm in film thickness) 38, metal films (Mo: 50 nm in film thickness, AlCu: 300 nm in film thickness) 39, and an upper transparent conductive film (ITO: 5 nm in film thickness) 40 are sequentially deposited using a sputtering apparatus (see FIG. 10A column (e)). The lower transparent conductive film 38 forms the transmissive pixel electrode. Further, the metal films 39 form the reflective pixel electrode.

Next, a resist 41 is patterned using half-tone exposure technology. In this case, the thickness of a portion corresponding to the reflective portion of the resist 41 is greater than the thickness of a portion corresponding to the transmissive portion. Further, the thickness of the portions of the resist 41 which are formed in an area excluding the reflective portion and in an area excluding the transmissive portion and in which the resist 41 is left is equal to or greater than the thickness of the reflective portion. Then, a wet etching process is carried out. Thus, the portions of the upper transparent conductive film 40, the metal film 39, and the lower transparent conductive film 38, which are not protected by the resist 41, are removed (see FIG. 10B column (f)).

Next, an ashing process is carried out to reduce the film thickness of the resist 41. Thus, the resist 41 formed in the transmissive portion is removed. In this case, the resist 41 reduced in film thickness is left in the reflective portion. Further, in an area in which the resist 41 having a film thickness equal to or greater than the thickness of the reflective portion is formed, the resist 41 reduced in film thickness is left. At the same time, in this step, a part of the organic planarization film 37 is removed in a film thickness direction. As a result, the thickness of the organic planarization film 38 formed above the TFT is reduced, for example (see FIG. 10B column (g)). Then, a wet etching process is carried out to remove the upper transparent conductive film 40 and the metal films 39 which are stacked in the transmissive portion. Thus, the transmissive pixel electrode is formed. Then, a resist removing process is carried out to remove the resist 41. Thus, the reflective pixel electrode is formed (see FIG. 10B column (h)). In this manner, the TFT array substrate is formed.

Also in the above-mentioned method, however, the upper transparent conductive film as well as the metal films are collectively etched in the wet etching process shown in FIG. 10B column (h). Accordingly, in the reflective pixel electrode, the edge portion of the upper transparent conductive film extends laterally from the edge portion of the metal films and remains in an eaves-like shape.

Further, in the method of manufacturing the TFT array substrate as described above, the lower transparent conductive film, the metal films, and the upper transparent conductive film are sequentially stacked and deposited. Then, in the wet etching process performed after the ashing process (see FIG. 10B column (h)), the upper transparent conductive film and the metal films are etched. In this case, it is necessary to perform selective etching so as to prevent the lower transparent conductive film from being etched. This leads to a problem of low process flexibility.

### SUMMARY OF THE INVENTION

The present invention has been made to solve the above-mentioned problems, and therefore an object of the present invention is to provide a display device that allows a reduction in manufacturing costs and an improvement in yield, and a method of manufacturing the same.

According to an aspect of the present invention, there is provided a method of manufacturing a display device, the display device including: a first substrate; a second substrate opposed to the first substrate; and a display material sandwiched between the first substrate and the second substrate, the method including the steps of: forming a base film on the first substrate; forming a reflective pixel electrode on the base film; forming a step on the base film; and depositing a transparent conductive film so as to be divided at the step of the base film after the step of forming the reflective pixel electrode.

According to the present invention, it is possible to reduce the manufacturing costs and improve the yield.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a partial cross-sectional view showing a liquid crystal display panel portion of a liquid crystal display device according to a first embodiment of the present invention;

FIG. 2 is a plane view showing the structure of a pixel of a TFT array substrate according to the first embodiment;

FIG. 3A is a process cross-sectional view showing a step of manufacturing the TFT array substrate according to the first embodiment;

FIG. 3B is a process cross-sectional view showing a step of manufacturing the TFT array substrate according to the first embodiment;

FIG. 4 is an enlarged cross-sectional view showing a reflective portion including a pixel/drain contact portion and a transmissive portion shown in FIG. 3B column (i);

FIG. 5 is a partial cross-sectional view showing a liquid crystal display panel portion of a liquid crystal display device according to a second embodiment of the present invention;

FIG. 6A is a process cross-sectional view showing a step of manufacturing a TFT array substrate according to the second embodiment;

FIG. 6B is a process cross-sectional view showing a step of manufacturing the TFT array substrate according to the second embodiment;

FIG. 7 is an enlarged cross-sectional view showing a reflective portion including a pixel/drain contact portion and a transmissive portion shown in FIG. 6B column (d);

FIG. 8 is an enlarged cross-sectional view showing a gate terminal and a source terminal which are shown in FIG. 6B column (d);

FIG. 9A is a process cross-sectional view schematically showing a step of manufacturing a TFT array substrate according to a related art;

FIG. 9B is a process cross-sectional view schematically showing a step of manufacturing the TFT array substrate according to the related art;

FIG. 9C is a process cross-sectional view schematically showing a step of manufacturing the TFT array substrate according to the related art;

FIG. 9D is a process cross-sectional view schematically showing a step of manufacturing the TFT array substrate according to the related art;

FIG. 10A is a process cross-sectional view showing a step of manufacturing a TFT array substrate according to a related art; and

FIG. 10B is a process cross-sectional view showing a step of manufacturing the TFT array substrate according to the related art.

### DESCRIPTION OF THE PREFERRED EMBODIMENTS

Hereinafter, embodiments to which the present invention can be applied will be described. Note that the present invention is not limited to exemplary embodiments described below. A liquid crystal display device will be explained below as a display device according to an exemplary embodiment of the present invention.

### First Embodiment

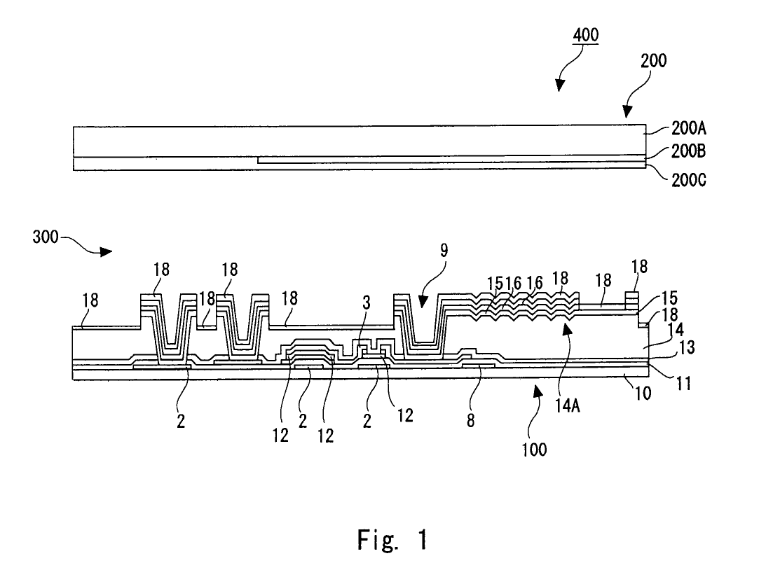

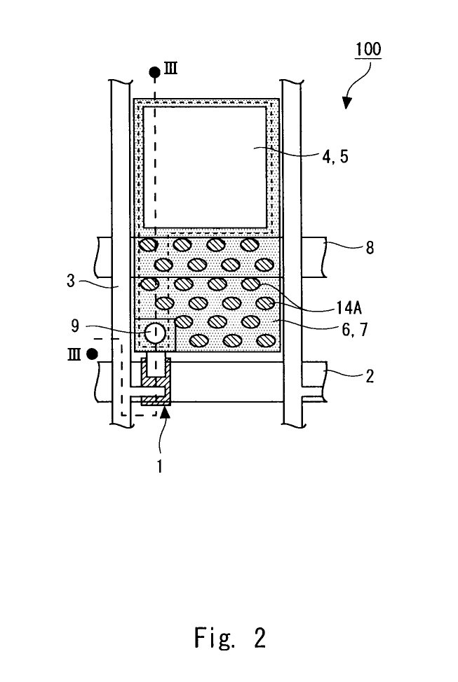

Referring first to FIGS. 1 and 2, a description is given of a liquid crystal display device 400 according to a first embodiment of the present invention. FIG. 1 is a partial cross-sectional view showing a liquid crystal display panel portion of the liquid crystal display device 400 according to the first embodiment of the present invention. FIG. 2 is a plane view showing the structure of a pixel of a TFT array substrate 100 according to the first embodiment of the present invention.

Referring to FIG. 1, the liquid crystal display device 400 according to the first embodiment includes the TFT array substrate 100 (first substrate), an opposing substrate 200 (second substrate) opposed to the TFT array substrate 100, and a liquid crystal layer 300 (display material) sandwiched between the TFT array substrate 100 and the opposing substrate 200. Note that the liquid crystal layer 300, which is sandwiched between the TFT array substrate 100 and the opposing substrate 200, and sealing materials and spacers, which are provided to keep a distance between the TFT array substrate 100 and the opposing substrate 200 constant, are omitted in FIG. 1.

In the TFT array substrate 100, thin film transistors (TFTs) 1 are formed in an array. Specifically, in the TFT array substrate 100, a gate line 2 and a source/drain line 3 are formed on a transparent insulating substrate (hereinafter, referred to as “glass substrate”) 10 so as to intersect with each other for each pixel (see FIG. 2). Each of the TFTs 1 is formed at an intersection of the gate line 2 and the source/drain line 3. Further, in the TFT array substrate 100, a transmissive portion 5 having a transmissive pixel electrode 4, a reflective portion 7 having a reflective pixel electrode 6, a storage capacitor line 8, a contact hole 9, and the like are formed for each pixel on the glass substrate 10 (see FIG. 2). The transmissive portion 5 and the reflective portion 7 form a pixel area.

The gate line 2 serves as a gate electrode so as to form the TFT 1 serving as a switching element. Further, the storage capacitor line 8 is disposed in parallel with the gate line 2 and is positioned near the center of the pixel area. The storage capacitor line 8 forms a storage capacitor for holding a voltage, which is applied to both the transmissive pixel electrode 4 and the reflective pixel electrode 6, for a predetermined period of time. On the TFT array substrate 100, driver ICs to which various signals are supplied from the outside are disposed. An end of the gate line 2 serves as a gate terminal and is electrically connected to a pad formed on each of the driver ICs. In this case, an image scanning signal sent from the outside is input to the gate line 2. Then, the gate line 2 transmits the image scanning signal to the TFT 1.

An insulating film 11 made of a transparent inorganic insulating material is formed so as to cover the gate line 2 and the storage capacitor line 8. A semiconductor layer 12 is formed above the gate line 2 via the insulating film 11, thereby forming the TFT 1. Further, a part of the semiconductor layer 12 which is formed above the gate line 2 is removed, thereby forming a TFT channel portion.

The source/drain line 3 serves as a source electrode so as to form the TFT 1. An end of the source/drain line 3 serves as a source terminal and is electrically connected to a pad formed on each of the driver ICs. In this case, an image signal output from the outside is input to the source/drain line 3. Then, the source/drain line 3 transmits the image signal to the TFT 1. An area surrounded by the gate line 2 and the source/drain line 3, which are adjacent to each other, serves as a pixel area, and pixels are arranged in a matrix on the TFT array substrate 100.

Further, the source/drain line 3 serves as a drain electrode so as to form the TFT 1. At least a part of the source/drain line 3 overlaps the storage capacitor line 8, which is formed below the source/drain line 3, via the insulating film 11. In this structure, an electric charge is stored between the storage capacitor line 8 and the source/drain line 3, thereby forming a storage capacitor.

An insulating film 13 is made of a transparent inorganic insulating material and is formed so as to cover the TFT 1, the gate line 2, and the source/drain line 3. An organic planarization film 14 (base film) is made of a transparent organic resin material and is formed so as to cover the insulating film 13.

At least a part of the organic planarization film 14 has a plurality of concave/convex shapes 14A to scatter reflected light. The plurality of concave/convex shapes 14A are formed over an area from the vicinity of the gate line 2 to the storage capacitor line 8 in each pixel area excluding the TFT 1 (see FIG. 2). Thus, on the surface of the organic planarization film 14, irregularities that determine reflection characteristics are formed.

Further, metal films 16 serving as reflective conductive films are formed above the concave/convex shapes 14A of the organic planarization film 14. Specifically, the metal films 16 are formed in substantially the same area as the concave/convex shapes 14A, and are formed in approximately a half of the pixel area excluding the TFT 1. The area in which the metal films 16 are formed serves as the reflective portion 7. In this case, light entering from a visible side is reflected on the metal films 16 and exits to the visible side.

A lower transparent conductive film 15 that constitutes the transmissive pixel electrode 4 is formed over substantially the entire pixel area excluding the TFT 1. Further, the metal films 16 are disposed on the lower transparent conductive film 15. In other words, the lower transparent conductive film 15 is formed on the organic planarization film 14, and the metal films 16 are formed on the lower transparent conductive film 15. In each pixel area, an area in which the metal films 16 are not formed on the lower transparent conductive film 15 serves as the transmissive portion 5, and an area in which the metal films 16 are formed on the lower transparent conductive film 15 serves as the reflective portion 7. Specifically, a part of the lower transparent conductive film 15 is formed so as to extend off the area in which the metal films 16 are formed. A portion of the lower transparent conductive film 15, which extends off the area in which the metal films 16 are formed, serves as the transmissive portion 5. The lower transparent conductive film 15 is made of a transparent conductive material. Further, the transmissive pixel electrode 4 formed of the lower transparent conductive film 15 applies a signal potential to the liquid crystal layer 300.

Above the source/drain line 3, the contact hole 9 is formed. The contact hole 9 is formed so as to penetrate the insulating film 13 and the organic planarization film 14. The transmissive pixel electrode 4 is connected to the source/drain line 3 formed therebelow, via the contact hole 9.

Referring to FIG. 1, the opposing substrate 200 includes a glass substrate 200A, a color filter layer 200B, and an opposing electrode 200C. The color filter layer 200B includes, for example, black matrix (BM), red (R), green (G), and blue (B) colored layers. The color filter layer 200B is formed in the pixel area on the lower surface of the glass substrate 200A made of glass or the like to thereby perform color display. The opposing electrode 200C is disposed on the side of the liquid crystal layer 300 of the opposing substrate 200, and applies a common potential for supplying a signal potential to the liquid crystal layer 300. Further, the TFT array substrate 100 and the opposing substrate 200 are bonded together with sealing materials so as to be opposed to each other, and the liquid crystal layer 300 is sealed therebetween.

Further, on the surfaces of the TFT array substrate 100 and the opposing substrate 200, a liquid crystal alignment layer (not shown) for alignment of liquid crystal is applied and formed. To obtain the liquid crystal alignment layer, it is possible to employ a rubbing method which has been widely applied in recent years. A transflective liquid crystal display device panel according to the first embodiment is structured as described above.

Note that, among methods of forming the liquid crystal alignment layer, a photo-alignment method, an inorganic alignment layer (vertical alignment method), an oblique vapor deposition method, an ion-beam alignment method, a nanoimprint method, and the like may be applied instead of the rubbing method. By those methods, an alignment defect area generated at a step portion or the like can be reduced in principle as compared with the rubbing method. As a result, a wide effective pixel area can be secured. Further, it is possible to prevent a reduction in yield due to generation of a foreign substance which is a drawback of the rubbing method. Furthermore, it is possible to reduce a damage to devices due to static electricity. Moreover, the number of cleaning steps executed after the rubbing method for removing the foreign substance can be reduced, which is advantageous in improving the productivity.

In the liquid crystal display device 400 according to the first embodiment, the TFT 1 serving as a switching element is formed in each pixel so as to drive the transmissive pixel electrode 4 formed of the lower transparent conductive film 15. The source/drain line 3 is electrically connected to the transmissive pixel electrode 4. Further, the TFT 1 is connected to the gate line 2. A signal input from the gate line 2 controls ON/OFF of the TFT 1. The TFT 1 is connected to the source/drain line 3. The source/drain line 3 connected to the TFT 1 applies a display voltage to the transmissive pixel electrode 4.

In this case, an electric field corresponding to the display voltage is generated between the transmissive pixel electrode 4 and the opposing electrode 200C. The electric field generated between the substrates drives the liquid crystal. In other words, as an alignment direction of the liquid crystal sandwiched between the substrates varies, a polarized state of light allowed to transmit through the liquid crystal layer 300 varies. Further, an actual voltage (driving voltage) applied to the liquid crystal can be varied by arbitrarily controlling the display voltage applied to the source/drain line 3. A voltage applied to the liquid crystal can be controlled with the source/drain line 3. Thus, as for driving conditions of the liquid crystal, intermediate transmittance of the liquid crystal can be freely set.

Further, on the outer surfaces of the TFT array substrate 100 and the opposing substrate 200, a polarizing plate (not shown), a retardation plate (not shown), and the like are disposed. On a non-visible side of the liquid crystal display panel, a backlight unit (not shown) and the like are disposed. The polarizing plate absorbs light oscillating in one direction and allows only light oscillating in another direction to pass, thereby producing linearly-polarized light. The retardation plate mainly produces specific phase differences of λ/2 and λ/4. A retardation plate that produces the phase difference of λ/2 and a retardation plate that produces the phase difference of λ/4 are referred to as a λ/2 plate and a λ/4 plate, respectively. Those retardation plates are used for optical compensation as well as enlargement of a view angle.

In the transmissive portion 5, light incident from the backlight passes through the polarizing plate formed on the side of the TFT array substrate 100 and becomes linearly-polarized light, and further passes through the retardation plate. As a result, the specific phase difference is produced. Furthermore, the light passing through the glass substrate 10 enters the liquid crystal layer 300. When the light passes through the liquid crystal layer 300, the polarized state of the light varies. After that, the light passing through the glass substrate 200A, the retardation plate, and the polarizing plate becomes linearly-polarized light and exits to the visible side.

In the reflective portion 7, light incident from the visible side passes through the polarizing plate formed on the side of the opposing substrate 200 and becomes linearly-polarized light, and further passes through the retardation plate. As a result, the specific phase difference is produced. Furthermore, the light passing through the glass substrate 200A enters the liquid crystal layer 300. When the light passes through the liquid crystal layer 300, the polarized state of the light varies. Then, the light entering the liquid crystal layer 300 is reflected on the metal films 16. Thus, the light passes through the liquid crystal layer 300 again, which varies the polarized state of the light. After that, the light passing through the glass substrate 200A, the retardation plate, and the polarizing plate becomes linearly-polarized light and exits to the visible side.

Depending on the polarized state of the light passing through the liquid crystal layer 300, an amount of light passing through the polarizing plate formed on the side of the opposing substrate 200 varies. In other words, the amount of light, which passes through the polarizing plate formed on the visible side, among transmitted lights transmitting from the backlight unit through the liquid crystal display panel and reflected lights entering from the outside varies. The alignment direction of the liquid crystal varies depending on the display voltage to be applied. Accordingly, by controlling the display voltage, the amount of light passing through the polarizing plate formed on the visible side can be varied. In short, by varying the display voltage by each pixel, a desired image can be displayed.

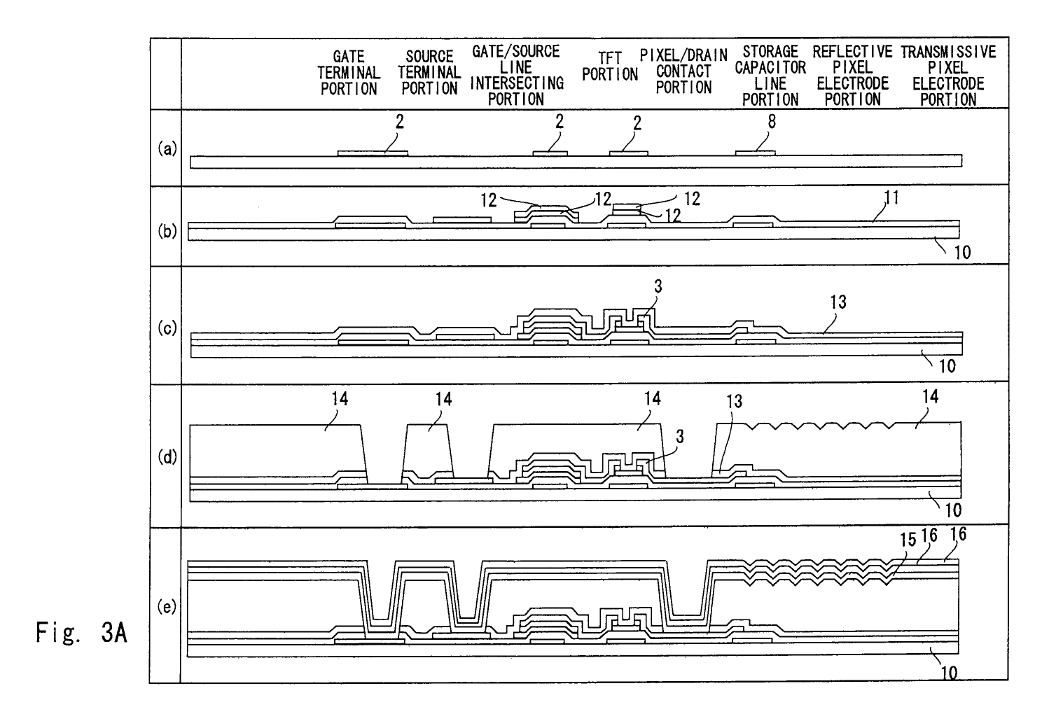

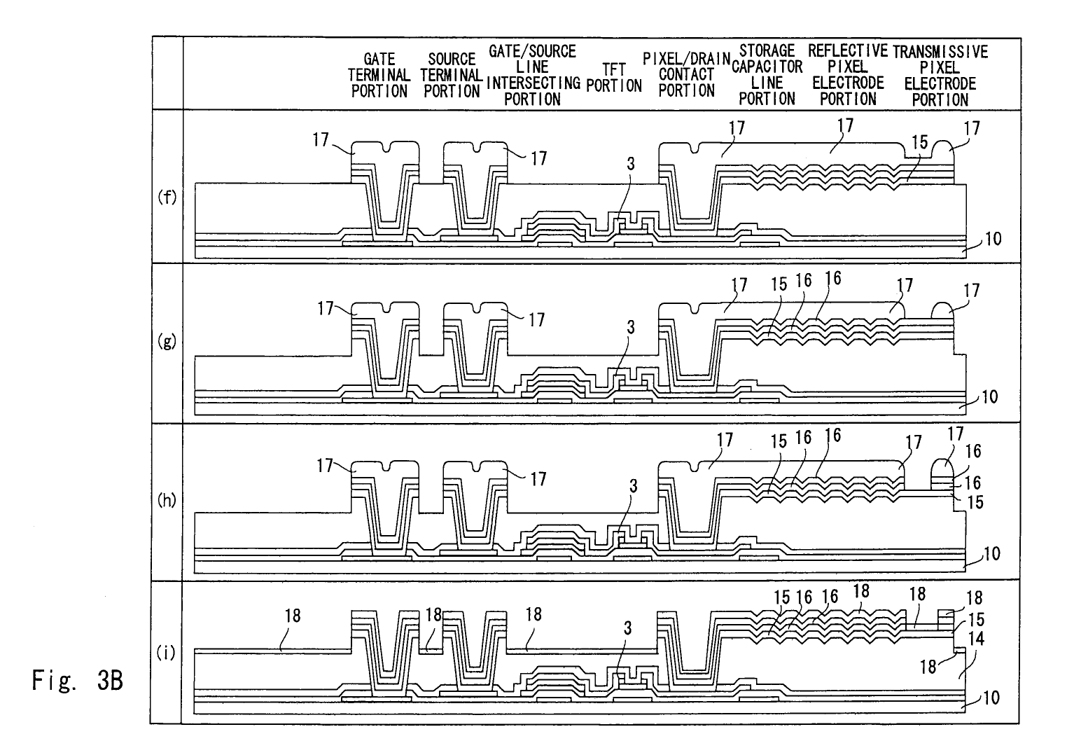

Next, a description is given of a method of manufacturing the liquid crystal display device 400 according to the first embodiment of the present invention. In particular, a method of manufacturing the TFT array substrate 100 according to the method of manufacturing the liquid crystal display device 400 is herein described with reference to FIGS. 3A and 3B. FIGS. 3A and 3B are process cross-sectional views each showing a step of manufacturing the TFT array substrate 100 according to the first embodiment. Note that FIGS. 3A and 3B are cross-sectional views each showing a cross section of a gate terminal portion and a cross section of a source terminal portion as well as a cross section taken along the line III-III of FIG. 2.

First, a Mo film having a thickness of 250 nm is deposited on the glass substrate 10 by using a sputtering apparatus. Next, a resist is patterned by using a photolithography apparatus. In short, a resist pattern is formed by a photolithography method. Then, a wet etching process is carried out to remove the portions of the Mo film which are not protected by the resist. Then, a resist removing process is carried out to remove the resist. Thus, the gate line 2 and the storage capacitor line 8 are formed (see FIG. 3A column (a); gate forming step).

Next, the insulating film (SiN: 400 nm in film thickness) 11 and semiconductor films (a-Si(i): 130 nm in film thickness, a-Si(n): 50 nm in film thickness) are deposited by using a CVD apparatus. Then, a resist is patterned by using a photolithography apparatus. Then, a dry etching process is carried out to remove the portions of the semiconductor film which are not protected by the resist. Further, a resist removing process is carried out to remove the resist. Thus, the semiconductor layers 12 are formed (see FIG. 3A column (b); semiconductor layer forming step).

Next, a Mo film having a thickness of 300 nm is deposited by using a sputtering apparatus. Then, a resist is patterned by using a photolithography apparatus. Further, a wet etching process is carried out to remove the portions of the Mo film which are not protected by the resist. Then, a dry etching process is carried out to remove the portions of the semiconductor film (a-Si (n)) which are not protected by the resist. Then, a resist removing process is carried out to remove the resist. Thus, the source/drain line 3 is formed (see FIG. 3A column (c); source/drain and channel forming step).

Next, the insulating film (SiN: 100 nm in film thickness) 13 is deposited by using a CVD apparatus (see FIG. 3A column (c)). Then, a photosensitive organic resin film is applied and formed. Further, the organic planarization film 14 having the concave/convex shapes 14A is formed by using a photomask for forming an uneven pattern and a photolithography apparatus. In this case, the concave/convex shapes 14A are formed in the reflective portion 7 in which the reflective pixel electrode 6 is formed. At the same time, a contact hole opening which becomes the contact hole 9 is formed in each of the gate terminal portion, the source terminal portion, and a pixel/drain contact portion. Then, a dry etching process is carried out to remove the portions of the insulating film 13 and the insulating film 11 which are formed in the contact hole openings (see FIG. 3A column (d); organic planarization film forming step). The above-mentioned steps are substantially the same as those of the conventional case.

Next, the lower transparent conductive film (ITO (Indium Tin Oxide) film: 80 nm in film thickness) 15 and the metal films (Mo: 50 nm in film thickness, AlCu: 300 nm in film thickness) 16 serving as reflective conductive films are sequentially deposited by using a sputtering apparatus (see FIG. 3A column (e)). The lower transparent conductive film 15 forms the transmissive pixel electrode 4. Further, the metal films 16 form the reflective pixel electrode 6.

Then, a resist 17 is patterned using half-tone exposure technology. In this case, the thickness of the portion corresponding to the reflective portion 7 of the resist 17 is greater than the thickness of the portion corresponding to the transmissive portion 5. The transmissive portion 5 corresponds to an area excluding the reflective portion 7 in each pixel area. Further, the thickness of the portions of the resist 17 which are formed in an area excluding the reflective portion 7 and in an area excluding the transmissive portion 5 and in which the resist 17 is left is equal to or greater than the thickness of the reflective portion 7.

Next, a wet etching process for etching the metal films 16 is carried out. In the first embodiment of the present invention, an isotropic etching process is carried out using an edge face of a resist pattern. In this case, the cross-sectional shape of the metal films 16 along a thickness direction is formed into a non-tapered shape. After the wet etching process for etching the metal films 16, a wet etching process for etching the lower transparent conductive film 15 is carried out. In the first embodiment, the etching processes are collectively carried out using the same etching solution. As a matter of course, the etching processes can be performed using different liquid chemicals. Thus, the portions of the metal films 16 and the lower transparent conductive film 15 which are not protected by the resist 17 are removed (see FIG. 3B column (f)).

Then, an ashing process is carried out to reduce the film thickness of the resist 17, thereby removing the portion of the resist 17 which is formed in the transmissive portion 5. As a result, the metal film 16 of the transmissive portion 5 is exposed. In this case, the resist 17 reduced in film thickness is left in the reflective portion 7. Further, in the area in which the resist 17 having a film thickness equal to or greater than that of the reflective portion 7 is formed, the resist 17 reduced in film thickness is left. Accordingly, the metal films 16 formed in the reflective portion 7 are covered with the resist 17.

In this step, a part of the exposed organic planarization film 14 is removed in the film thickness direction at the same time. Thus, the film thickness of the organic planarization film 14 formed above the TFT 1 is reduced, for example. In this case, steps formed between the lower surface of the lower transparent conductive film 15 and the organic planarization film 14 removed by the ashing process are sufficiently secured. This is because an upper transparent conductive film 18 to be described later stacked on the organic planarization film 14 is prevented from being brought into contact with the lower transparent conductive film 15 when the upper transparent conductive film 18 is formed. Specifically, it is desirable to form steps having a height of 100 nm or more by reducing the thickness of the organic planarization film 14 through the ashing process. In the first embodiment, steps having a height of 500 nm are formed (see FIG. 3B column (g)).

Next, a wet etching process is carried out to remove the metal films 16 stacked in the transmissive portion 5. Thus, the transmissive pixel electrode 4 and the reflective pixel electrode 6 are formed (see FIG. 3B column (h)). Then, a resist removing process is carried out to remove the resist 17. As a result, the reflective pixel electrode 6 is exposed. Then, the upper transparent conductive film (ITO film: 5 nm in film thickness) 18 is deposited (see FIG. 3B column (i) Thus, the TFT array substrate 10 is formed.

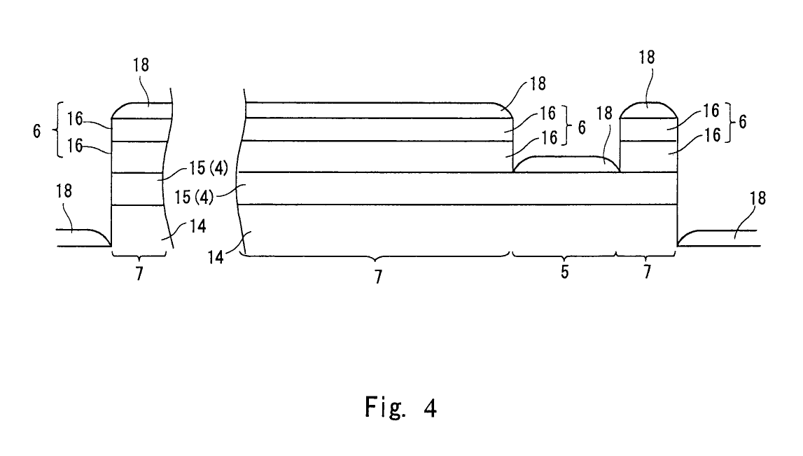

FIG. 4 shows an enlarged view of each of the reflective portion 7 including the pixel/drain contact portion and the transmissive portion 5 shown in FIG. 3B column (i). Note that the pixel/drain contact portion and the concave/convex shapes 14A of the reflective pixel electrode 6 are omitted in FIG. 4.

The thickness of the upper transparent conductive film 18 is set to, for example, 5 nm. The upper transparent conductive film 18 is deposited so as to be divided into sections at the step portion formed on the TFT array substrate 100. For example, referring to FIG. 4, the upper transparent conductive film 18 is divided at the steps formed on the outer periphery of each of the reflective pixel electrode 6 and the transmissive pixel electrode 4. In short, the upper transparent conductive film 18 is deposited so as to be divided into sections for each pixel.

Further, referring to FIG. 3B column (i), the upper transparent conductive film 18 is deposited so as to be divided at an edge portion of each of the gate terminal portion and the source terminal portion in the same manner as described above. The steps formed on the outer periphery of each of the reflective pixel electrode 6 and the transmissive pixel electrode 4 and on the outer periphery of each of the gate terminal portion and the source terminal portion correspond to the sum of steps of the metal films 16, which forms the reflective pixel electrode 6, the lower transparent conductive film 15, and the organic planarization film 14 reduced in thickness through the ashing process. Accordingly, the height of the steps formed on the outer periphery of each of the reflective pixel electrode 6 and the transmissive pixel electrode 4 and on the outer periphery of each of the gate terminal portion and the source terminal portion is much greater than the thickness of the upper transparent conductive film 18. For this reason, it is impossible for the upper transparent conductive film 18 to cross over the steps formed on the outer periphery of each of the reflective pixel electrode 6 and the transmissive pixel electrode 4 and on the outer periphery of each of the gate terminal portion and the source terminal portion.

Specifically, in the first embodiment, the step formed between the surface of the organic planarization film 14 obtained before the ashing process and the surface of the organic planarization film 14 reduced in thickness through the ashing process is about 500 nm. Accordingly, the steps formed on the outer periphery of each of the reflective pixel electrode 6 and the transmissive pixel electrode 4 and on the outer periphery of each of the gate terminal portion and the source terminal portion have a height of 930 nm. The upper transparent conductive film 18 has the thickness of 5 nm which is about equal to or smaller than 1/180 of the height of the steps. For this reason, it is impossible for the upper transparent conductive film 18 to cross over the steps. Thus, the upper transparent conductive film 18 formed on the reflective pixel electrode 6 and the upper transparent conductive film 18 formed at the step of the organic planarization film 14 can be electrically and physically divided without patterning the upper transparent conductive film 18.

Further, referring to FIG. 3B column (i), the area of the upper transparent conductive film 18 deposited on the reflective portion 7 is substantially equal to or a little smaller than the area of the reflective portion 7. The area of the upper transparent conductive film 18 deposited on the transmissive portion 5 is substantially equal to or a little smaller than the area of the transmissive portion 5. In other words, referring to FIG. 4, at a boundary between the reflective portion 7 and the transmissive portion 5, the position of the edge portion of the upper transparent conductive film 18 formed on the reflective pixel electrode 6 is the same as the position of the pattern edge portion of the reflective pixel electrode 6, or is set on the inner side of the pattern edge portion. Further, at the boundary between the reflective portion 7 and the transmissive portion 5, the position of the edge portion of the upper transparent conductive film 18 formed on the transmissive pixel electrode 4 is the same as the position of the edge portion of the transmissive portion 5, or is set on the inner side of the edge portion of the transmissive portion 5. In other words, the edge portion of the upper transparent conductive film 18 does not extend laterally from the pattern edge portion of the reflective pixel electrode 6, and is not formed into an eaves-like shape.

Note that the upper transparent conductive film 18 is made of a material having substantially the same work function as that of the opposing electrode 200C formed in the opposing substrate 200. In this case, the “substantially the same work function” means that a difference in work function equal to or smaller than 02 is included. A potential difference in the vicinity of both the electrodes is suppressed, thereby obtaining more preferable effects. Accordingly, the upper transparent conductive film 18 may be made of the same material as that of the opposing electrode 200C, for example. The example where an ITO film is used as the upper transparent conductive film 18 has been described above, but the upper transparent conductive film 18 may be formed of a transparent conductive film made of IZO, ITZO, ITSO, or the like.

As described above, in the liquid crystal display device 400 and the method of manufacturing the liquid crystal display device 400 according to the first embodiment of the present invention, the organic planarization film 14 is formed on the TFT array substrate 100, and the transmissive pixel electrode 4 and the reflective pixel electrode 6 are then formed on the organic planarization film 14. In the formation step, steps are formed in the organic planarization film 14, and then the upper transparent conductive film 18 is deposited. In this case, the upper transparent conductive film 18 is divided at the steps of the organic planarization film 14. More specifically, the upper transparent conductive film 18 is divided at the steps formed on the outer periphery of each of the reflective pixel electrode 6 and the transmissive pixel electrode 4 and on the outer periphery of each of the gate terminal portion and the source terminal portion. Further, the edge portion of the upper transparent conductive film 18 does not extend laterally from the outer periphery of each of the reflective pixel electrode 6 and the transmissive pixel electrode 4 and the outer periphery of each of the gate terminal portion and the source terminal portion, and is not formed into an eaves-like shape. Accordingly, unlike the conventional case, it is possible to prevent a malfunction due to fragments removed from the eaves-like shape of the transparent conductive film formed on the reflective pixel electrode during a post-process. Accordingly, it is possible to improve the yield of the liquid crystal display device 400.

Further, the upper transparent conductive film 18 having a work function substantially the same as that of the opposing electrode 200C is formed on the reflective pixel electrode 6. As a result, even if the reflective pixel electrode 6 is made of a material different from that of the opposing electrode 200C, such as the metal films 16, flicker or image sticking does not occur. Accordingly, the liquid crystal display device 400 with excellent display quality can be manufactured.

Further, the upper transparent conductive film 18 is deposited with a thickness smaller than the height of the steps formed in the organic planarization film 14. For this reason, the upper transparent conductive film 18 is deposited so as to be divided at the steps of the organic planarization film 14. In other words, the upper transparent conductive film 18 is divided at the steps formed on the outer periphery of each of the reflective pixel electrode 6 and the transmissive pixel electrode 4 and on the outer periphery of each of the gate terminal portion and the source terminal portion. Accordingly, it is not necessary to perform patterning of the upper transparent conductive film 18. As a result, the number of etching processes can be reduced, which leads to a reduction in manufacturing costs.

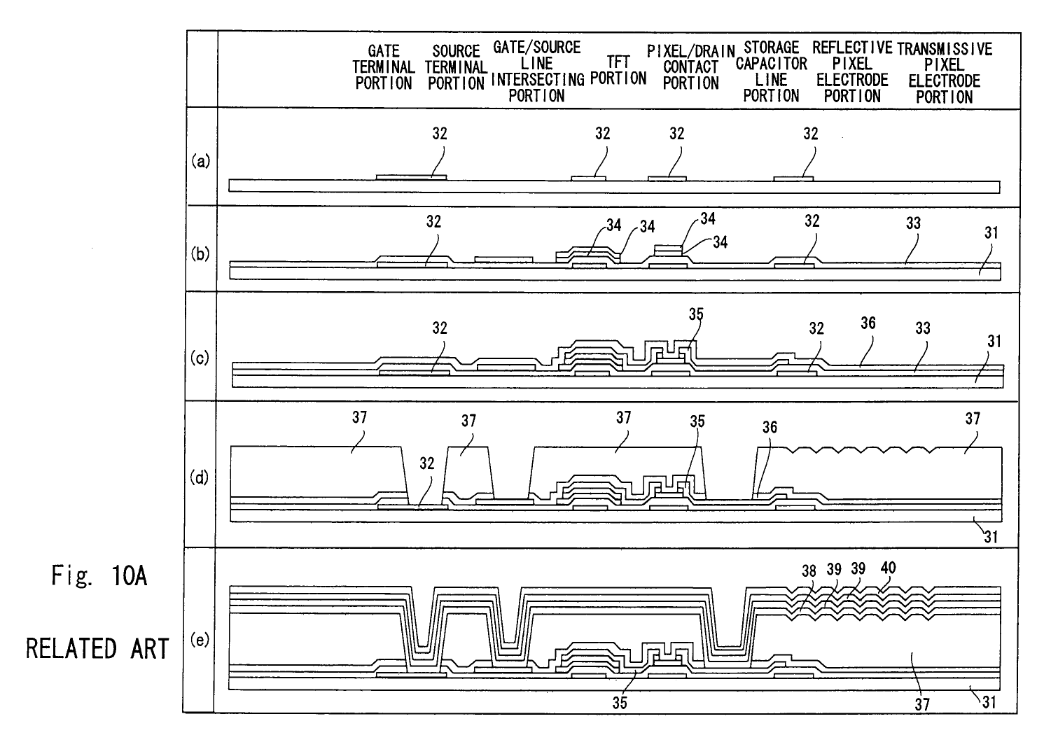

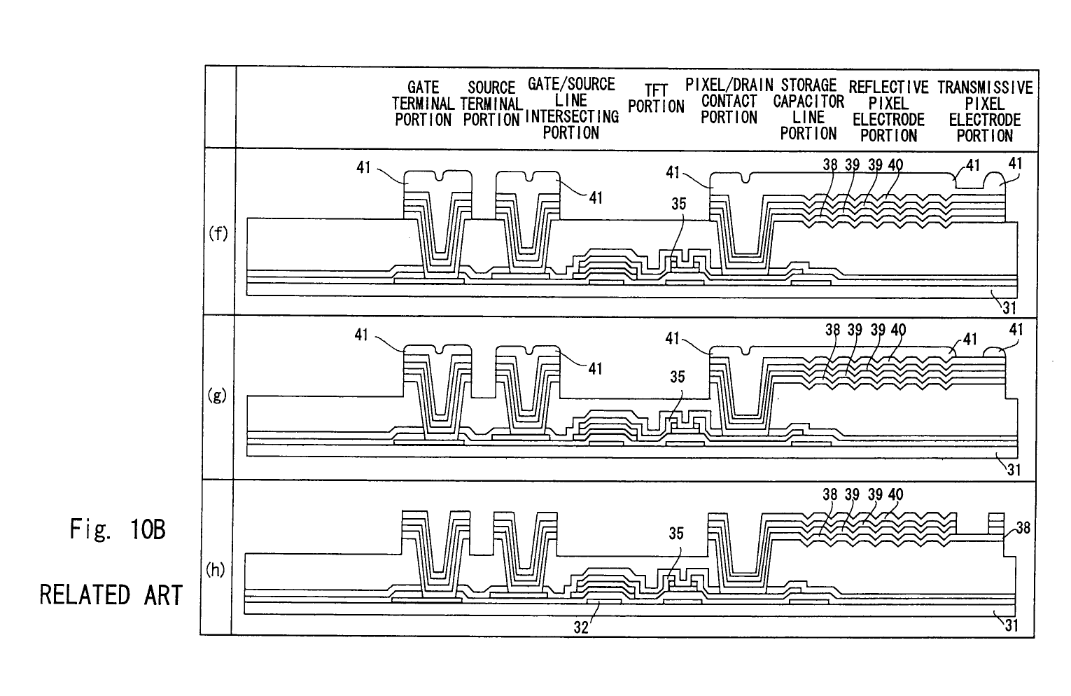

Further, the upper transparent conductive film 18 is deposited after the reflective pixel electrode 6 and the transmissive pixel electrode 4 are formed. Accordingly, it is only necessary to perform an etching process for etching the metal films 16 serving as the reflective pixel electrode 6 after the ashing process. Thus, unlike the example shown in FIGS. 10A and 10B, the restriction on the etching process for etching the upper transparent conductive film 40 and the metal films 39 while leaving the lower transparent conductive film 38 formed below the metal films 39 can be eliminated. As a result, the process flexibility can be increased.

Further, the upper transparent conductive film 18 formed in the portion in which the thickness of the organic planarization film 14 is reduced forms a conductive layer in a wide range of the liquid crystal display device 400. This is effective in preventing a damage due to static electricity generated in a panel assembling step or the like.

Further, in the first embodiment, the metal films 16 are left on the source terminal portion and the gate terminal portion. Specifically, instead of obtaining a halftone-exposed portion as in the patterning of the pixel electrode transmissive portion, a normal left pattern like the reflective area is used. If a half-tone exposure process is performed on a hole opening such as a contact hole with a depth corresponding to a depth of a terminal portion and the like, the film thickness of the resist tends to be uneven, which may cause the half-tone exposure process to be unstable. As described above, in the first embodiment, the metal films 16 are left on the source terminal portion and the gate terminal portion, which results in a reduction in a pattern failure and an improvement of the yield.

Note that, in the first embodiment, a single-gap structure in which the transmissive pixel electrode 4 is formed on the organic planarization film 14 has been described, but a dual-gap structure in which the transmissive pixel electrode 4 is formed in a portion obtained by removing the organic planarization film 14 can be employed.

Further, the materials of the gate line 2, the source/drain line 3, the reflective pixel electrode 6, the insulating films 11 and 13, and the transmissive pixel electrode 4 are not limited to the materials illustrated in the first embodiment. In particular, as the lower transparent conductive film 15 that forms transmissive pixel electrode 4, a transparent conductive film such as IZO, ITZO, or ITSO as well as ITO may be used. Further, not only a single-layer structure but also a multilayer structure may be employed. The same is applied to the upper transparent conductive film 18. The example of the reflective conductive film in which the two metal films 16 are stacked has been described, but a single-layer structure may be employed and three or more layers may be stacked. Films to be stacked in a multilayer structure may be the same layers or different layers. If the upper transparent conductive film and the lower transparent conductive film each have a stacked structure, at least one layer of the upper transparent conductive film may be directly connected to at least one layer of the lower transparent conductive film.

Further, in the first embodiment, the transflective liquid crystal display device including both the reflective pixel electrode 6 and the transmissive pixel electrode 4 is illustrated as the liquid crystal display device 400, but the present invention can also be applied to a reflective liquid crystal display device which does not include the transmissive pixel electrode 4 but includes the reflective pixel electrode 6 as a pixel electrode.

Further, in the first embodiment, the organic planarization film 14 is illustrated as a base film, but the base film is not limited thereto.

Further, the display material formed in a gap between the first substrate and the second substrate is not limited to the liquid crystal material, but a display material such as an organic EL can also be applied.

### Second Embodiment

Next, a description is given of an example of a liquid crystal display device according to the present invention which is different from that of the first embodiment. In the following description, the components identical with those of the first embodiment are denoted by the same reference symbols, and a description thereof is omitted as appropriate.

A basic structure and a method of manufacturing a liquid crystal display device according to a second embodiment of the present invention are similar to those of the first embodiment except for the following points. The liquid crystal display device of the first embodiment is different from that of the second embodiment of the present invention in the following points. That is, in the liquid crystal display device according to the first embodiment, a pattern side wall of the metal film serving as the reflective conductive film formed in the reflective pixel electrode has a non-tapered shape, while in the liquid crystal display device according to the second embodiment, a pattern side wall of the metal film serving as the reflective conductive film formed in the reflective pixel electrode has a forward tapered shape. In addition, in the liquid crystal display device according to the second embodiment, the lower transparent conductive film and the upper transparent conductive film are in direct electrical and physical contact with each other.

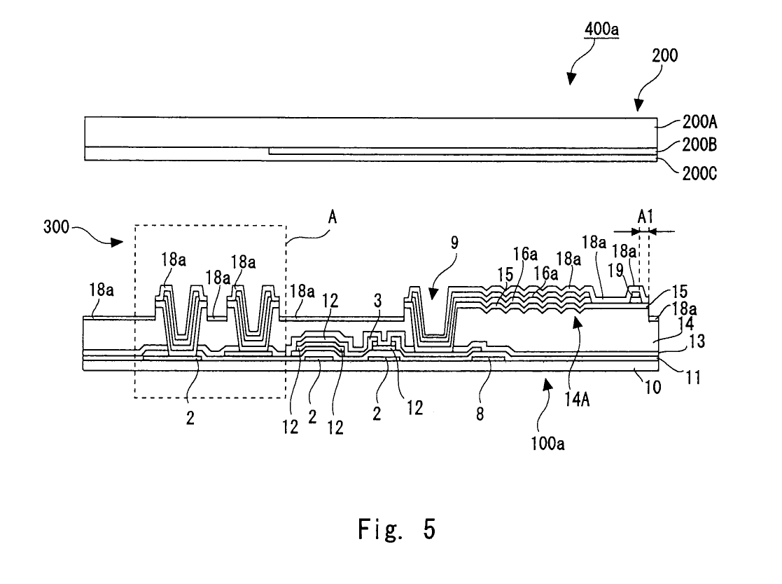

FIG. 5 shows a partial cross-sectional view of a liquid crystal display panel of a liquid crystal display device 400a according to the second embodiment. Note that the liquid crystal layer 300, which is sandwiched between a TFT array substrate 100a and the opposing substrate 200, and sealing materials and spacers, which are provided to keep a distance between the TFT array substrate 100a and the opposing substrate 200 constant, are omitted in FIG. 5.

A pattern side wall of metal films 16a serving as reflective conductive films according to the second embodiment has a forward tapered shape 19. In the same manner as in the first embodiment, the lower transparent conductive film 15 serving as the transmissive pixel electrode 4 is formed in substantially the entirety of each pixel area excluding the TFT 1. In the second embodiment, the lower transparent conductive film 15 and an upper transparent conductive film 18a are in direct physical and electrical contact with each other.

Specifically, in plane view, the lower transparent conductive film 15 positioned near a boundary between the lower transparent conductive film 15 and a step portion of the organic planarization film 14 has at least a frame-like extended area Al in an area provided on the outside of the metal film 16a. Further, the upper transparent conductive film 18a is formed so as to coat the entirety of the upper layer of the extended area A1, the pattern side wall of the metal film 16a having the forward tapered shape, and the upper layer of the metal film 16a in a unified manner. Thus, the lower transparent conductive film 15 and the upper transparent conductive film 18a are in direct contact with each other.

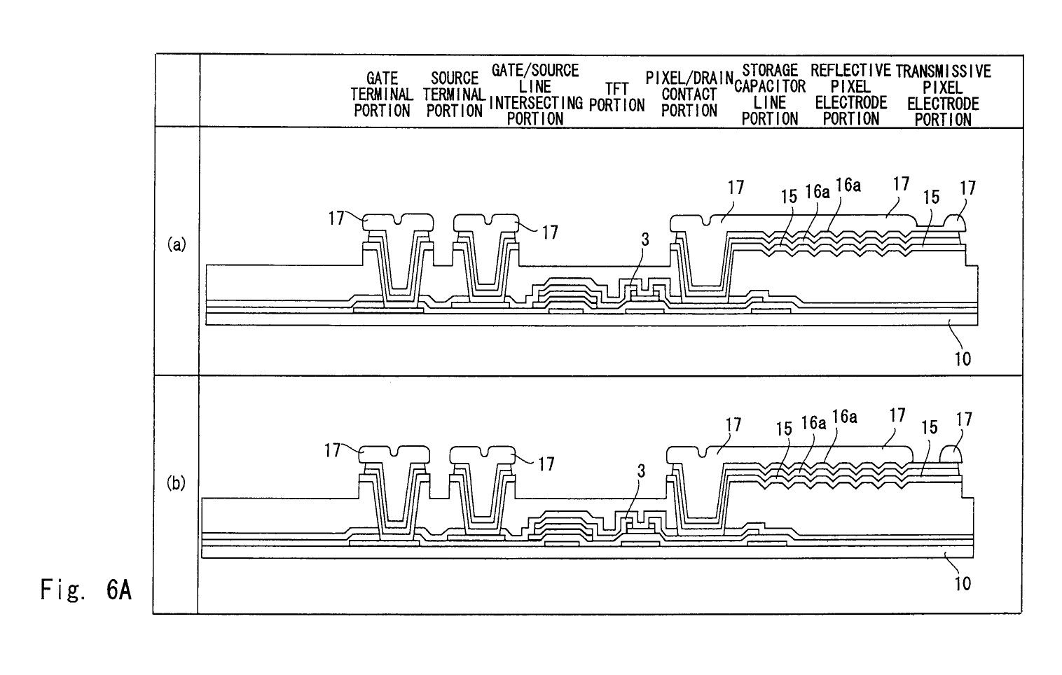

Referring next to FIGS. 6A and 6B, a description is given of a method of manufacturing the TFT array substrate 100a of the liquid crystal display device 400a according to the second embodiment. FIGS. 6A and 6B are process cross-sectional views each showing a step of manufacturing the TFT array substrate 10a according to the second embodiment, and each showing a process cross-sectional view of an area similar to that of FIGS. 3A and 3B according to the first embodiment. The steps shown in FIG. 3A, that is, the process from the gate forming step to the step of depositing the metal film 16a, are similar to those of the first embodiment, so illustration and description thereof are herein omitted.

In the same manner as in the first embodiment, the lower transparent conductive film 15 and the metal films 16a are sequentially deposited on the organic planarization film 14, and then the resist 17 is patterned using half-tone exposure technology. After that, a wet etching process for etching the metal film 16a is carried out. In the second embodiment, an etching process is carried out using an edge face of a resist pattern so that the side wall of the metal films 16a has a forward tapered shape. As an etching solution, mixed liquid chemical of phosphoric acid, acetic acid, nitric acid, and water can be used, for example. The mixed liquid chemical of phosphoric acid, acetic acid, nitric acid, and water can also be used as an etching solution such as normal Al or Mo. By increasing a ratio of the nitric acid as a composition ratio of the etching solution, the cross-sectional shape in the film thickness direction of the metal films, which are etched using the edge face of the resist patter, can be formed into a forward tapered shape. As a result, the portions of the metal films 16a which are not protected by the resist 17 can be removed and the pattern side wall can be formed into a tapered shape.

Next, a wet etching process for etching the lower transparent conductive film 15 is carried out. As an etching solution, oxalic acid can be used, for example. In some cases, mixed liquid chemical of hydrochloric acid, nitric acid, and water may be used. As a result, the portions of the lower transparent conductive film 15 which are not protected by the resist 17 can be removed (see FIG. 6A column (a)).

Then, an ashing process is carried out to reduce the film thickness of the resist 17, thereby removing the portions of the resist 17 which are formed in the transmissive portion 5. As a result, the metal film 16a of the transmissive portion 5 is exposed, and the resist 17 reduced in film thickness is left in the reflective portion 7 (see FIG. 6A column (b)). Further, in an area in which the resist 17 having a film thickness equal to or greater than that of the reflective portion 7 is formed, the resist 17 reduced in film thickness is left.

At the same time, in this step, a part of the organic planarization film 14 is removed in the film thickness direction (see FIG. 6A column (b)). As a result, the film thickness of the organic planarization film 14 formed above the TFT 1 is reduced, for example. In this case, in the same manner as the first embodiment, steps formed between the lower surface of the lower transparent conductive film 15 and the organic planarization film 14 removed through the ashing process are sufficiently secured. Specifically, it is desirable to form steps having a height equal to or greater than 100 nm by reducing the thickness of the organic planarization film 14 through the ashing process. In the second embodiment, steps having a height of 500 nm are formed.

Next, a wet etching process is carried out to remove the metal films 16a stacked in the transmissive portion 5. Thus, the transmissive pixel electrode 4 and a reflective pixel electrode 6a are formed (see FIG. 6B column (c)). Then, a resist removing process is carried out to remove the resist 17. As a result, the reflective pixel electrode 6a is exposed. After that, the upper transparent conductive film (ITO film: 5 nm in film thickness) 18a is deposited (see FIG. 6B column (d)). Thus, the TFT array substrate 10a is formed.

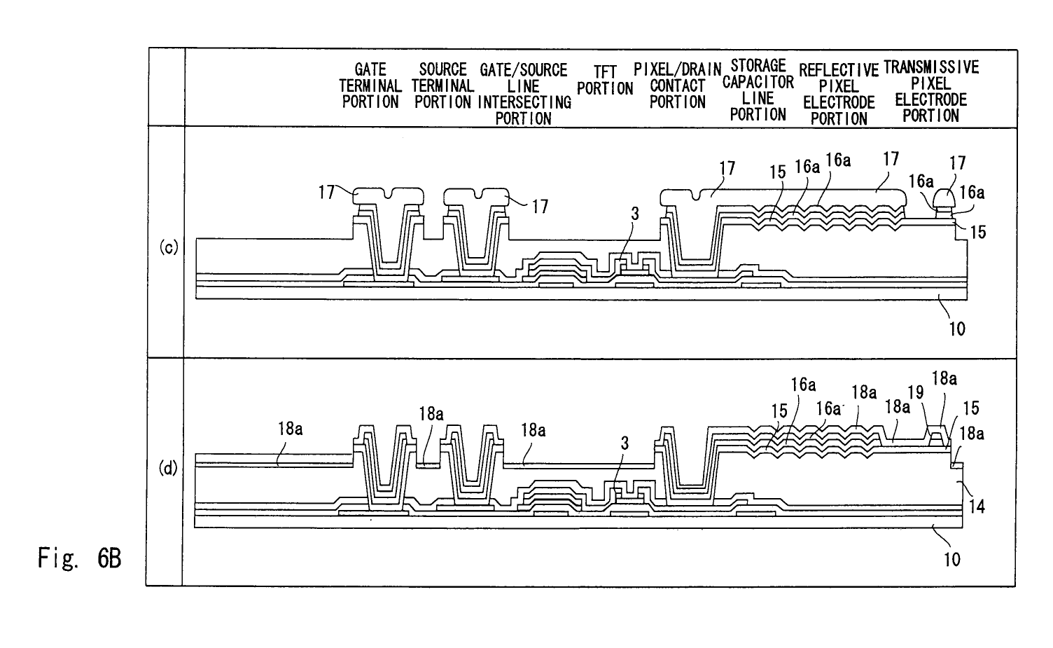

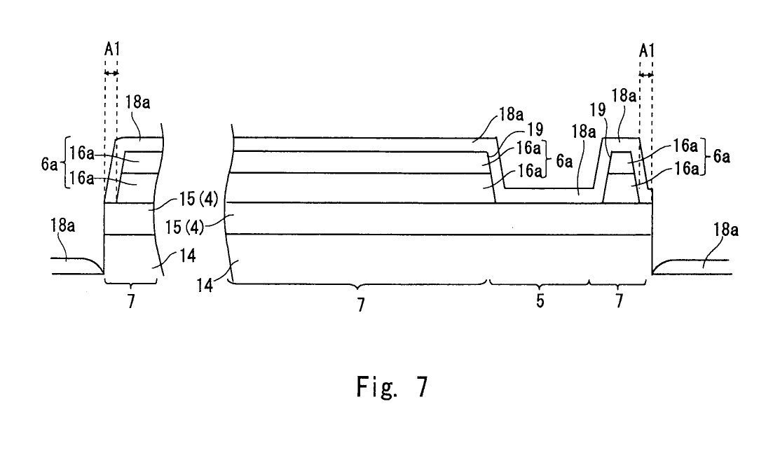

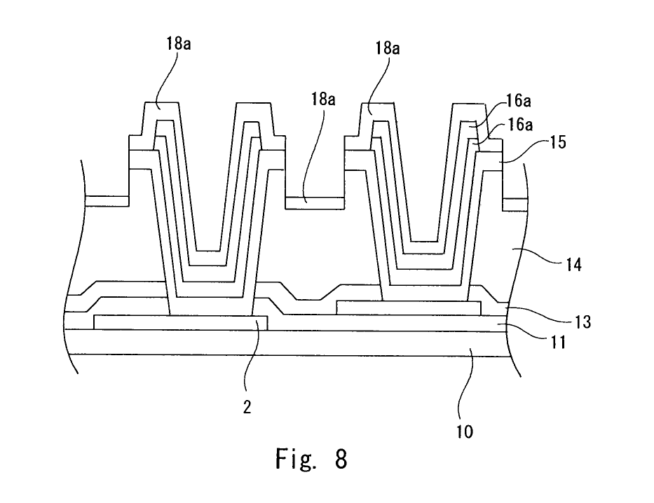

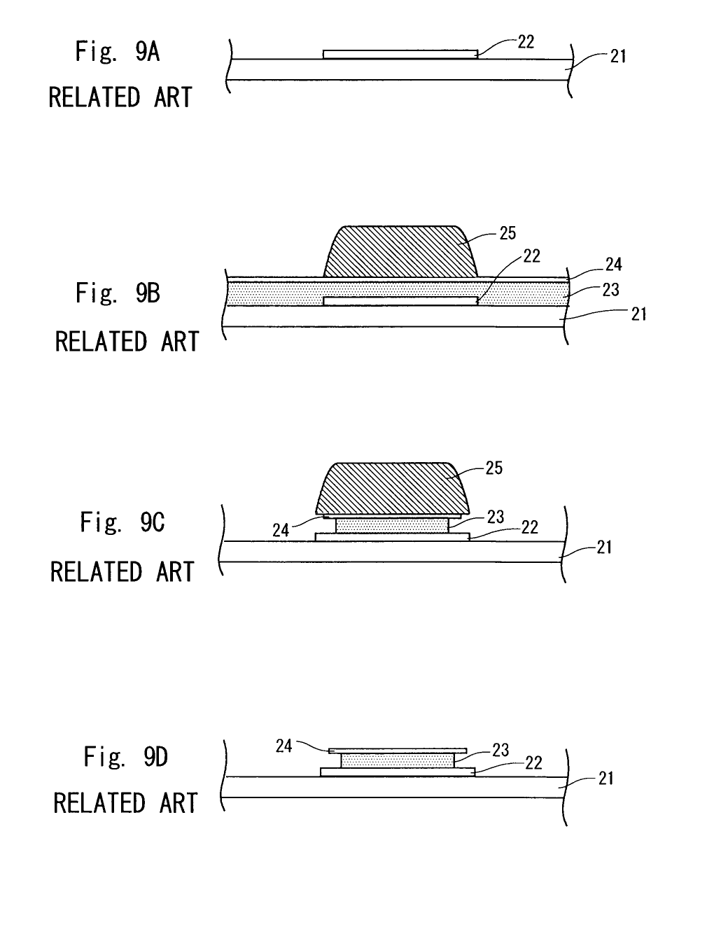

FIG. 7 shows an enlarged view of the reflective portion 7 including the pixel/drain contact portion and the transmissive portion 5 shown in FIG. 6B column (d). FIG. 8 shows an enlarged view of the gate terminal portion and the source terminal portion. Note that the pixel/drain contact portion and the concave/convex shapes 14A of the reflective pixel electrode 6a are omitted in FIG. 7.

The thickness of the upper transparent conductive film 18a is set to, for example, 5 nm. As described above, the upper transparent conductive film 18a and the lower transparent conductive film 15 are in direct contact with each other. Meanwhile, referring to FIG. 7, the upper transparent conductive film 18a is deposited so as to be divided at the step portion of the organic planarization film 14 on the TFT array substrate 100a. Specifically, the upper transparent conductive film 18a is deposited so as to be divided into sections for each pixel. Also in the edge portions of the gate terminal portion and the source terminal portion, the upper transparent conductive film 18a is deposited so as to be divided at the step portion of the organic planarization film 14.

The steps formed on the outer periphery of the transmissive pixel electrode 4 and on the outer periphery of each of the gate terminal portion and the source terminal portion correspond to the sum of steps of the lower transparent conductive film 15 and the organic planarization film 14 reduced in thickness through the ashing process. Accordingly, the steps formed on the outer periphery of the transmissive pixel electrode 4 and on the outer periphery of each of the gate terminal portion and the source terminal portion have a height much greater than the thickness of the upper transparent conductive film 18a. For this reason, it is impossible for the upper transparent conductive film 18a to cross over the steps formed on the outer periphery of the transmissive pixel electrode 4 and the outer periphery of each of the gate terminal portion and the source terminal portion. Referring to FIGS. 7 and 8, the edge portion of the upper transparent conductive film 18a does not extend laterally from the pattern edge portion of the reflective pixel electrode 6a and is not formed into an eaves-like shape.

According to the second embodiment, it is possible to prevent a malfunction due to fragments removed from the eaves-like portion of the transparent conductive film formed on the reflective pixel electrode during a post-process as in the first embodiment. As a result, the yield of the liquid crystal display device can be improved. Further, flicker or image sticking does not occur. Accordingly, the liquid crystal display device 400 with excellent display quality can be manufactured. Furthermore, it is not necessary to perform patterning of the upper transparent conductive film 18a, which leads to a reduction in the number of etching processes. As illustrated in the example shown in FIG. 10, the step of etching the upper transparent conductive film and the metal film while leaving the lower transparent conductive film formed below the metal films is eliminated, which increases the process flexibility. In addition, the upper transparent conductive film 18a is formed in a wide range, which is effective in preventing a damage due to static electricity generated during a panel assembling step or the like.

Further, in the second embodiment, the pattern side wall of the metal film 16a is formed into a tapered shape, and at least the frame-like extended area A1 of the lower transparent conductive film 15 is formed in the area provided on the outside of the metal film 16a. Furthermore, the upper transparent conductive film 18a is deposited so as to coat the entirety of the upper layer of the metal film 16a, the pattern side wall of the metal film 16a, and the extended area A1 of the lower transparent conductive film 15 in a unified manner. Thus, the upper transparent conductive film 18a and the lower transparent conductive film 15 are in direct contact with each other. As a result, the electric resistance of each electrode or each terminal contact area can be reduced, thereby providing more flexibility in choice of material of the reflecting electrode. Accordingly, the process flexibility is increased. For example, when the metal film 16a to be in contact with the upper transparent conductive film 18a is selected, a material with a high electric resistance at the boundary face can be selected. Thus, it is also possible to select the material with high reflectance as a material of the metal film 16a on a higher priority to thereby provide a bright display with excellent reflectance. Meanwhile, at the same brightness, power consumption of the device can be reduced.

Note that, in the second embodiment, as a method of bringing the upper transparent conductive film 18a into direct contact with the lower transparent conductive film 15, the following method is illustrated. That is, the pattern side wall of the metal films serving as the reflective conductive films is formed into the tapered shape and the frame-like extended area A1 of the low transparent conductive film 15 is formed in the area provided on the outside of the metal film 16a, and then the upper transparent conductive film 18a is formed so as to coat the entirety of the extended area A1, the pattern side wall of the metal films 16a, and the upper layer of the metal films 16a in a unified manner. Alternatively, as long as the upper transparent conductive film 18a and the lower transparent conductive film 15 are in direct contact with each other, various modifications can be made without departing from the gist of the present invention. For example, though the example where the lower transparent conductive film 15 has the pattern side wall formed into a non-tapered shape has been described above, the following structure can also be employed. That is, the pattern side wall of the lower transparent conductive film 15 may be formed into a forward tapered shape in a similar manner as the metal films 16a, and the upper transparent conductive film may be coated over the pattern side wall of the lower transparent conductive film and the pattern side wall of the tapered shape of the metal films, thereby bringing the upper transparent conductive film into direct contact with the lower transparent conductive film.

Though the pattern edge of the resist 17 has substantially an eaves-like shape corresponding to the tapered shape of the metal films 16a as shown in FIG. 6A column (a), the eaves-like shape does not cause a problem because the resist 17 is removed after the transmissive pixel electrode 4 and the reflective pixel electrode 6a are formed. The pattern edge of the resist 17 has an eaves-like shape (not shown) in FIGS. 3B and 10B, but the eaves-like shape does not cause a problem also in this case because the resist 17 is removed after the transmissive pixel electrode 4 and the reflective pixel electrode 6 are formed.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A method of manufacturing a display device, the display device including: a first substrate; a second substrate opposed to the first substrate; and a display material sandwiched between the first substrate and the second substrate, the method comprising the steps of:
forming a base film on the first substrate;
forming a reflective pixel electrode on the base film;
forming a step at the base film; and
depositing an upper transparent conductive film so as to be divided at the step of the base film after the step of forming the base film.

2. The method of manufacturing a display device according to claim 1, further comprising the step of forming a transmissive pixel electrode on the first substrate so that the transmissive pixel electrode extends off a pattern of the reflective pixel electrode,
wherein, in the step of forming the upper transparent conductive film, the upper transparent conductive film is deposited on at least the reflective pixel electrode and the transmissive pixel electrode.

3. The method of manufacturing a display device according to claim 1, wherein, in the step of forming the reflective pixel electrode, at least one layer of a reflective conductive film is deposited and etched so that a pattern side wall of the reflective conductive film is formed into a forward tapered shape.

4. The method of manufacturing a display device according to claim 2, wherein, in the step of forming the reflective pixel electrode, at least one layer of a reflective conductive film is deposited and etched so that a pattern side wall of the reflective conductive film is formed into a forward tapered shape.

5. The method of manufacturing a display device according to claim 3, wherein:
in the step of forming the transmissive pixel electrode, a lower transparent conductive film is deposited below the reflective conductive film and above the base film; and
in the step of depositing the upper transparent conductive film, the upper transparent conductive film is coated on the pattern side wall of the reflective conductive film so that the lower transparent conductive film and the upper transparent conductive film are brought into direct contact with each other.

6. The method of manufacturing a display device according to claim 4, wherein:
in the step of forming the transmissive pixel electrode, a lower transparent conductive film is deposited below the reflective conductive film and above the base film; and
in the step of depositing the upper transparent conductive film, the upper transparent conductive film is coated on the pattern side wall of the reflective conductive film so that the lower transparent conductive film and the upper transparent conductive film are brought into direct contact with each other.

7. The method of manufacturing a display device according to claim 1, wherein:
the second substrate includes an opposing electrode formed thereon so as to face the first substrate; and
the upper transparent conductive film has a work function substantially the same as a work function of the opposing electrode.

8. The method of manufacturing a display device according to claim 1, wherein the upper transparent conductive film is deposited with a thickness smaller than a height of the step of the base film.

9. A display device, comprising:
a first substrate;
a second substrate opposed to the first substrate;
a display material sandwiched between the first substrate and the second substrate;
a base film formed on the first substrate and having a step;
a reflective pixel electrode formed above the base film; and
an upper transparent conductive film formed above the reflective pixel electrode and divided at the step of the base film.

10. The display device according to claim 9, further comprising a transmissive pixel electrode formed so as to extend off a pattern of the reflective pixel electrode of the first substrate,
wherein the upper transparent conductive film is formed above at least the reflective pixel electrode and the transmissive pixel electrode.

11. The display device according to claim 9, wherein:
the reflective pixel electrode is formed of at least one layer of a reflective conductive film; and
a pattern side wall of the reflective conductive film has a forward tapered shape.

12. The display device according to claim 10, wherein:
the reflective pixel electrode is formed of at least one layer of a reflective conductive film; and
a pattern side wall of the reflective conductive film has a forward tapered shape.

13. The display device according to claim 11, wherein:
the transmissive pixel electrode is formed of a lower transparent conductive film formed above the base film and below the reflective conductive film; and
the upper transparent conductive film is coated over an upper layer of the reflective conductive film, the pattern side wall of the reflective conductive film, and the lower transparent conductive film extending from the pattern side wall of the reflective conductive film so that the upper transparent conductive film and the lower transparent conductive film are brought into direct contact with each other.

14. The display device according to claim 12, wherein:
the transmissive pixel electrode is formed of a lower transparent conductive film formed above the base film and below the reflective conductive film; and
the upper transparent conductive film is coated over an upper layer of the reflective conductive film, the pattern side wall of the reflective conductive film, and the lower transparent conductive film extending from the pattern side wall of the reflective conductive film so that the upper transparent conductive film and the lower transparent conductive film are brought into direct contact with each other.

15. The display device according to claim 9, wherein:
the second substrate includes an opposing electrode formed thereon so as to face the first substrate; and
the transparent conductive film has a work function substantially the same as a work function of the opposing electrode.

16. The display device according to claim 9, wherein the transparent conductive film has a thickness smaller than a height of the step of the base film.
